(19) United States
(12) Patent Application Publication
(10) Pub. No.: US 2023/0246802 A1
(43) Pub. Date: Aug. 3, 2023

(54) SYNCHRONIZED SENSOR PARAMETER CONVERSIONS

(71) Applicant: TEXAS INSTRUMENTS INCORPORATED, Dallas, TX (US)

(72) Inventor: Amit ASHARA, Wylie, TX (US)

(21) Appl. No.: 17/732,344

(22) Filed: Apr. 28, 2022

Related U.S. Application Data
(60) Provisional application No. 63/305,957, filed on Feb. 2, 2022.

(51) Int. Cl. H04L 7/00; H04L 67/12

(52) U.S. Cl. CPC H04L 7/0041; H04L 67/12

(57) ABSTRACT

In examples, a sensor device is adapted to be coupled, by a shared power and data connection (SPDC), to other sensor devices in a chain of sensor devices. The sensor device comprises a sensor to sense a parameter, a counter, and a controller coupled to the sensor and the counter. The controller is configured to determine, based on an index position of the sensor device, a time that is to elapse between receipt of a command to convert the sensed parameter to a digital code and a conversion of the sensed parameter to the digital code. The controller is configured to, responsive to receipt of the command, set the counter to the time. The controller is configured to convert the sensed parameter to the digital code upon the counter indicating that the time has elapsed.

### CROSS-REFERENCE TO RELATED APPLICATIONS

The present application claims priority to U.S. Provisional Patent Application No. 63/305,957, which was filed Feb. 2, 2022, is titled “A METHOD TO SCHEDULE DATA CONVERSION USING POSITION IDENTIFIER ON A BUS WITHOUT HANDSHAKING,” and is hereby incorporated herein by reference in its entirety.

### BACKGROUND

Sensor devices are useful to sense a variety of environmental parameters, such as temperature, pressure, humidity, and light. In some cases, distributed sensor devices are useful to detect environmental parameters in multiple locations. For example, a chain of temperature sensor devices coupled in parallel may be positioned in multiple areas of a large auditorium to determine an average temperature throughout the auditorium. Distributed sensor devices may convert sensed parameters to digital codes that are subsequently provided to a controller. For instance, a first temperature sensor device in a chain of temperature sensor devices may convert a sensed temperature of 70 degrees Fahrenheit to a first digital code, and a second temperature sensor device in that chain of temperature sensor devices may convert a sensed temperature of 65 degrees Fahrenheit to a second digital code that differs from the first digital code.

### SUMMARY

In examples, a sensor device is adapted to be coupled, by a shared power and data connection (SPDC), to other sensor devices in a chain of sensor devices. The sensor device comprises a sensor to sense a parameter, a counter, and a controller coupled to the sensor and the counter. The controller is configured to determine, based on an index position of the sensor device, a time that is to elapse between receipt of a command to convert the sensed parameter to a digital code and a conversion of the sensed parameter to the digital code. The controller is configured to, responsive to receipt of the command, set the counter to the time. The controller is configured to convert the sensed parameter to the digital code upon the counter indicating that the time has elapsed.

In examples, a method comprises determining an index position of a sensor device in a chain of sensor devices coupled to each other by a shared power and data connection (SPDC) based on a first digital code provided to a set of pins of the sensor device or based on a sensed voltage on a pin of the sensor device. The method also includes calculating a time that is to elapse between receipt of a command to convert a sensed parameter to a digital code and the conversion of the sensed parameter to the digital code by summing a fixed delay time and a product of the index position and a duration of the conversion. The method also includes, responsive to receiving the command, waiting for the time to elapse. The method also includes, responsive to the time elapsing, converting the sensed parameter to a second digital code. The method also includes storing the second digital code to a storage in the sensor device.

### BRIEF DESCRIPTION OF THE DRAWINGS

FIG. 1 is a block diagram of a sensor system including a controller coupled to a chain of sensor devices, in accordance with various examples.

FIG. 2 is a block diagram of a sensor system including a controller coupled to a chain of sensor devices by way of a shared power and data connection (SPDC), in accordance with various examples.

FIG. 3 are timing diagrams of communications on an SPDC and of sensed parameter conversions performed by sensor devices in a chain of sensor devices, in accordance with various examples.

FIG. 4 is a flow diagram of a method for performing synchronous sensor parameter conversions on an SPDC coupling a controller to a chain of sensor devices, in accordance with various examples.

FIG. 5 is a block diagram of a sensor system including a controller coupled to a chain of sensor devices by way of an SPDC, in accordance with various examples.

The same reference numbers or other reference designators are used in the drawings to designate the same or similar (functionally and/or structurally) features.

### DETAILED DESCRIPTION

As described above, a controller may be coupled to a chain of sensor devices by way of an SPDC. An SPDC may be a single wire that is configured to carry both power and data in an alternating fashion between a controller and multiple sensor devices. Sensor devices in the chain draw increased current from the SPDC when converting sensed environmental parameters into digital codes. If too many sensor devices in the chain perform such parameter conversions simultaneously, the total current drawn from the SPDC rises sharply, thereby causing the voltage on the SPDC to fall. The drop in voltage on the SPDC may be significant enough (e.g., below a threshold voltage) to cause the sensor devices in the chain to interpret the drop as a signal form the controller (e.g., a signal that the controller is preparing to broadcast a message to the sensor devices on the SPDC). Such a signal is unintended and results in communication errors on the SPDC. A solution to mitigate the drop in voltage on the SPDC due to simultaneous sensor parameter conversions includes providing a low-resistance pull-up resistor connected to the SPDC via a switch. Prior to simultaneous parameter conversions across multiple sensor devices in a chain, the switch is turned on, thereby providing an increased current supply to the SPDC via a low impedance current path and preventing a total current draw on the SPDC of a magnitude that would cause the voltage on the SPDC to drop below the aforementioned threshold voltage. However, such a solution adds expense and needlessly occupies space (e.g., due to the need for additional circuit components and additional controller package pins).

This disclosure describes various examples of a sensor system that facilitates synchronized sensor parameter conversions while mitigating the challenges associated with other solutions, such as the challenges described above. In examples, a controller is coupled to a chain of sensor devices (e.g., packaged or unpackaged semiconductor devices configured to sense ambient temperature). The chain of sensor devices may include any number of sensor devices. Each sensor device in the chain is configured to determine its index position in the chain. For example, the first sensor device in the chain is configured to determine that it is the first sensor device in the chain, the second sensor device in the chain is configured to determine that it is the second sensor device in the chain, and so on. Each sensor device is configured to determine, based on its index position in the chain, a start time at which it is to sense a parameter and/or convert the sensed parameter to a digital code. The start times of the sensor devices in the chain are staggered in such a way that the number of sensor devices that are simultaneously sensing parameters and/or converting the sensed parameters to digital codes is controlled to be below a predetermined target (e.g., no more than two sensor devices simultaneously converting sensed parameters to digital codes at a time). The converted digital codes may be stored on the sensor devices for subsequent interrogation by the controller.

By using this staggered approach, all sensor devices in the chain are able to sense parameters and convert the sensed parameters to digital codes, but the total current draw at any given time on the SPDC (that supplies both power and data to the sensor devices in the chain) remains low. Consequently, the voltage on the SPDC remains sufficiently high so as to avoid causing the sensor devices to interpret the voltage on the SPDC to mean that the controller is imminently broadcasting a message to the various sensor devices in the chain. The sensor system thus senses parameters and converts parameters to digital codes without the communication errors described above, and further without any need for the expensive and/or space-consuming additional switches, passive components, controller package pins, cables and wires, traces, ground planes, changes to controller software, and low impedance current paths that characterize various conventional solutions.

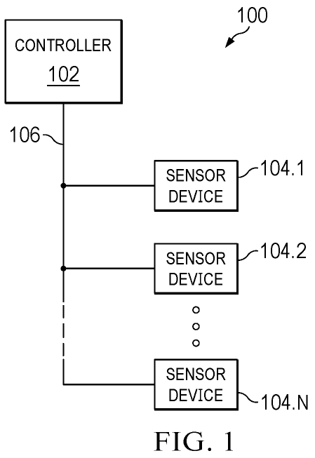

FIG. 1 is a block diagram of a sensor system 100, in accordance with various examples. The sensor system 100 may include a controller 102, such as a microcontroller, microcomputer, microprocessor, digital circuitry, analog circuitry, software and/or other controlling or processing device. The controller 102 may be coupled to multiple sensor devices 104.1, 104.2, . . . , 104.N (hereinafter individually or collectively referred to as “sensor devices 104”) by way of an SPDC 106. The SPDC 106 is a single wire that is configured to carry both power and data in an alternating fashion between the controller 102 and the multiple sensor devices 104. The sensor devices 104 may sense any of a variety of parameters, such as temperature, pressure, light, sound, etc. In examples, the sensor devices 104 sense the same parameters, and in other examples, the sensor devices sense different parameters, and in still other examples, some sensor devices sense a common parameter while other sensor devices sense other parameters. In operation, and as described in detail below, the controller 102 enables each of the sensor devices 104 to determine its index position in the chain of sensor devices 104. For example, the controller 102 may enable the sensor device 104.1 to determine that it is the first sensor device in the chain of sensor devices 104, and so on. Based on its index position in the chain of sensor devices 104, each sensor device 104 calculates a start time T_{START} at which that sensor device 104 is to sense a parameter and/or convert the sensed parameter to a digital code. Because each sensor device 104 uses a different index position value to calculate its start time, each start time is different. For example, because the sensor device 104.2 uses a different index position value than sensor device 104.1 to calculate its start time, the sensor device 104.2 has a different (e.g., later) start time than sensor device 104.1. Each sensor device 104 includes a counter or timer that is set according to the calculated start time of that sensor device 104. The controller 102 may broadcast a parameter conversion command on the SPDC 106, and, in response to receiving the parameter conversion command, all of the sensor devices 104 initiate their counters at the same time or at approximately the same time. As the counter of each sensor device 104 reaches the calculated start time of that sensor device 104, that sensor device 104 senses a parameter and/or converts a sensed parameter to a digital code. Because each of the sensor devices 104 has a different start time owing to a different index position in the chain of sensor devices 104, the sensor devices 104 will sense and/or convert parameters in a staggered fashion. In examples, the sensor devices 104 may calculate their respective start times in such a way that no more than M sensor devices 104 sense and/or convert a parameter at a given time, where M is an integer greater than or equal to 1 but less than N (e.g., M is 1, M is 2). The sensor devices 104 then store the converted parameters as digital codes for subsequent interrogation by the controller 102. The sensor system 100 may be implemented in various applications, including industrial, home, and automotive applications.

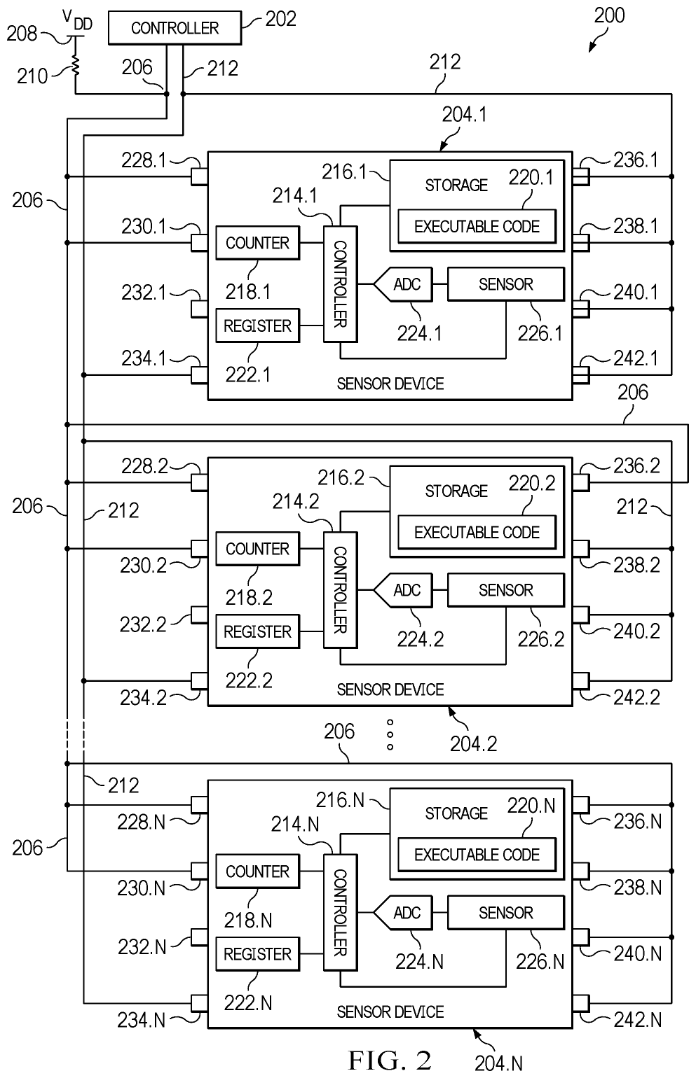

FIG. 2 is a block diagram of a sensor system 200, in accordance with various examples. The sensor system 200 may be an example implementation of sensor system 100 in FIG. 1. The sensor system 200 may include a controller 202 coupled to a chain of sensor devices 204.1, 204.2, . . . , 204.N (hereinafter collectively referred to as “sensor devices 204”) by way of an SPDC 206. The controller 202 is similar to the controller 102 of FIG. 1. The sensor devices 204 are similar to the sensor devices 104 of FIG. 1. The SPDC 206 is similar to the SPDC 106 of FIG. 1. In examples, the sensor device 204.1 may be a semiconductor device (which may be fabricated on a single semiconductor die and/or packaged within a single semiconductor package) that includes a set of pins, balls or leads (hereinafter referred to as pins) 228.1, 230.1, 232.1, and 234.1 along one side of the package and another set of pins 236.1, 238.1, 240.1, and 242.1 along an opposite side of the package. In alternative examples, the pins are implemented on the bottom of the device. The scope of this disclosure is not limited to any particular number or configuration of pins, and the techniques depicted in the drawings and described herein may be extended to any pin configuration. Example sensor devices 204 in which the structures and techniques described herein may be implemented include the LMT01, BQ2022, BQ2026, TMP18x, and TMP182x devices produced by TEXAS INSTRUMENTS INCORPORATED®.

The pin 228.1 may be coupled to the SPDC 206 and may obtain power from voltage source 208 via SPDC 206. The pin 230.1 also may be coupled to the SPDC 206 to facilitate the exchange of data/instructions between the controller 202 and the sensor device 204.1 via SPDC 206 (e.g., the SPDC 206 may be a serial data output (SDQ) bus). Power may be provided on SPDC 206 when data is not being provided on SPDC 206. In examples, the pin 232.1 is not used. The pin 234.1 may be coupled to a ground connection 212 to provide sensor device 204.1 with access to ground. The pins 236.1, 238.1, 240.1, and 242.1 may be coupled to the ground connection 212.

Still referring to FIG. 2, the sensor device 204.1 may include a controller 214.1(e.g., a microcontroller, microcomputer, microprocessor, analog circuitry, digital circuitry and/or a state machine) coupled to storage 216.1 (e.g., any type of volatile or non-volatile memory) storing executable code 220.1. The executable code 220.1, when executed by the controller 214.1, causes the controller 204.1 to perform some or all of the actions attributed herein to the controller 214.1 and/or the sensor device 204.1. The controller 214.1 may further be coupled to a counter 218.1 and a register 222.1. The controller 214.1 may be coupled to an analog-to-digital converter (ADC) 224.1, which, in turn, may be coupled to a sensor 226.1 (e.g., a temperature, pressure, humidity, light or acoustic sensor). The controller 214.1 may be directly connected to the sensor 226.1 in some examples.

The sensor devices 204.2 through 204.N are similar, but not identical, to the sensor device 204.1. Specifically, the description provided above of the pin configuration and internal components of the sensor device 204.1 also apply to the sensor devices 204.2 and 204.N, with like numerals referring to like pin configurations and components, with the exception of the configurations of the pins 236.2, 238.2, 240.2, 242.2 (for sensor device 204.2) and pins 236.N, 238.N, 240.N, and 242.N (for sensor device 204.N). Pin 236.2 may be coupled to the SPDC 206, while the remaining pins 238.2, 240.2, and 242.2 may be coupled to the ground connection 212. Pins 236.N, 238.N, 240.N, and 242.N may be coupled to the SPDC 206. In examples, N=16, and thus each of the four pins 236.X, 238.X, 240.X, and 242.X (where X is an integer between 1 and N) may be coupled to the SPDC 206 and/or the ground connection 212 in a different combination, since 2⁴=16.

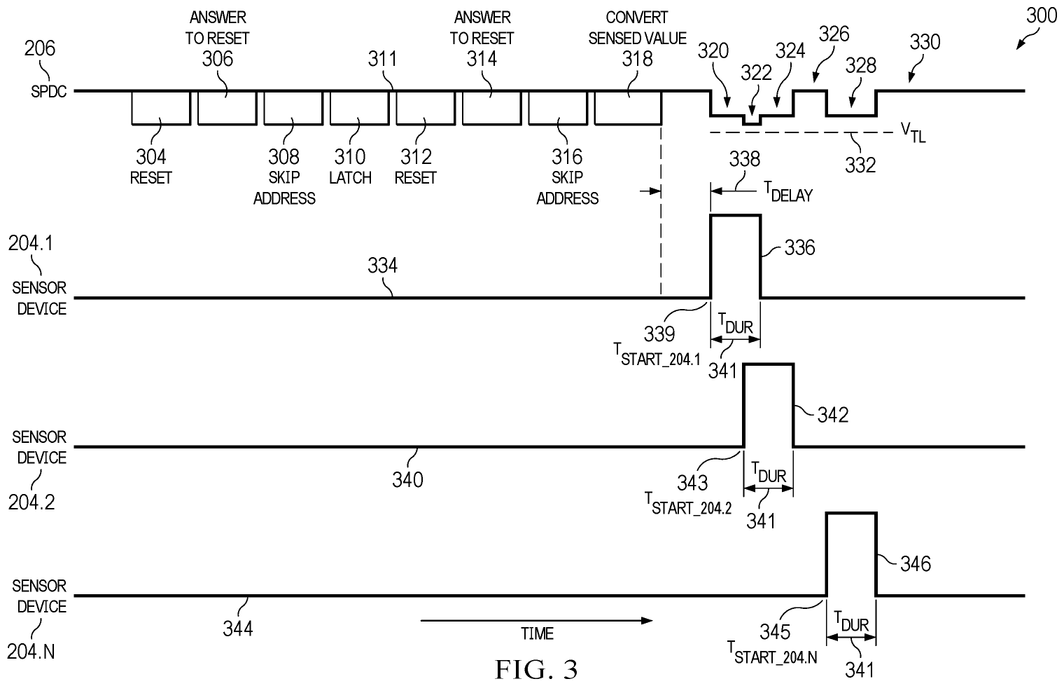

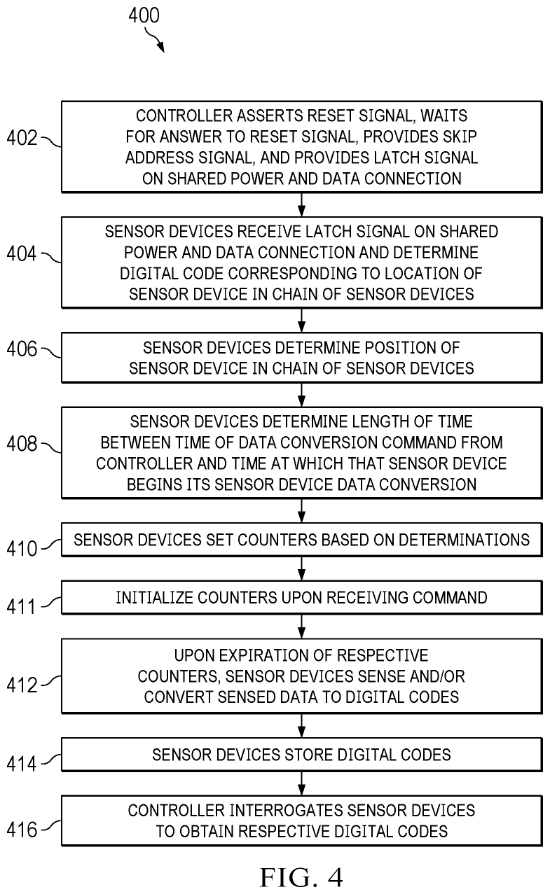

The SPDC 206 may be coupled to a power supply VDD 208 by way of a resistor 210. In examples, the resistor 210 has a resistance (and the VDD 208 is configured to provide a voltage) adequate to enable the functionalities of the sensor system 200 as described herein. The resistance of the resistor 210 and the voltage provided by the VDD 208 may be determined by an engineer or designer of the sensor system 200. FIG. 3 includes timing diagrams of communications on an SPDC (e.g., SPDC 206) and of sensed parameter conversions performed by sensor devices in a chain of sensor devices (e.g., sensor devices 104 and/or 204), in accordance with various examples. The x-axis depicts time and the y-axis for the top-most diagram depicts signals 304, 306, 308, 310, 312, 314, 316, and 318 issued on the SPDC 206. The y-axis for the top-most diagram depicts voltages 320, 322, 324, 326, 328, and 330 on the SPDC 206. The y-axes for the bottom three diagrams depict whether a corresponding sensor device 204.1, 204.2, or 204.N, respectively, is performing a parameter measurement or conversion. FIG. 4 is a flow diagram of a method 400 for performing synchronous sensor parameter conversions on an SPDC (e.g., SPDC 206) coupling a controller (e.g., controllers 214.1, 214.2, . . . , 214.N) to a chain of sensor devices (e.g., sensor devices 204), in accordance with various examples. Accordingly, FIGS. 2-4 are described, below, in parallel.

The method 400 begins with each sensor device 204 determining its respective index position in the chain of sensor devices 204 (blocks 402, 404). Specifically, the controller 202 may assert a reset signal 304 on the SPDC 206, which causes a transient dip in the voltage on SPDC 206. One purpose of the reset signal 304 is to initialize the sensor devices 204. The controller 202 may wait for an answer 306 on the SPDC 206 from one or more of the sensor devices 204, and upon receiving an answer from at least one of the sensor devices 204, the controller 202 may issue a skip address command 308 on the SPDC 206 to the sensor devices 204. The skip address command instructs each of the sensor devices 204 to execute the next instruction to arrive on the SPDC 206 irrespective of that sensor device's address or an address that may be specified in that next instruction. The next instruction may include a latch instruction 310 issued by the controller 202. The latch instruction 310 is received and executed by each of the sensor devices 204 due to the skip address command 308 received just prior to the latch instruction 310. The latch instruction 310, when executed by the sensor devices 204, causes each of the sensor devices 204 to capture the digital code present on pins 236.X, 238.X, 240.X, and 242.X {X=1 . . . N}. For example, because pins 236.1, 238.1, 240.1, and 242.1 are all coupled to ground connection 212, the sensor device 204.1 captures a digital code 0000. Similarly, because pin 236.2 is coupled to SPDC 206 (which, after the latch instruction 310 is complete, returns to a baseline value determined by VDD 208 and resistor 210 at 311), pin 236.2 captures a high value while the remaining pins 238.2, 240.2, and 242.2 are all coupled to ground connection 212 and thus capture low values. Thus, the sensor device 204.2 captures a digital code 0001. Likewise, because pins 236.N, 238.N, 240.N, and 242.N are all coupled to SPDC 206, the sensor device 204.N may capture a digital code 1111. Intervening sensor devices between sensor devices 204.2 and 204.N may capture other digital codes, e.g., a sensor device 204.3 may capture a digital code 0010. In examples, the controller 214.X {X=1 . . . } of each sensor device 204 captures the digital code for that sensor device and stores it to the storage 216.X {X=1 . . . }.

Each of the sensor devices 204 uses its captured digital code to determine its index position in the chain of sensor devices 204 (block 406). Thus, for instance, because the sensor device 204.1 captures 0000, the controller 214.1 determines that the sensor device 204.1 has an index position of 0 in the chain of sensor devices 204. Similarly, because the sensor device 204.2 captures 0001, the controller 214.2 determines that the sensor device 204.2 has an index position of 1 in the chain of sensor devices 204, and so on. In this way, each sensor device 204 is configured to determine its position relative to the other sensor devices 204 in the chain of sensor devices 204. Each sensor device 204 is configured to store the captured digital code and/or index position in a respective register 222.X {X=1 . . . N}. Each sensor device 204 may store a lookup table (e.g., programmed by an engineer or designer of the system 200) useful to convert a captured digital code to an index position.

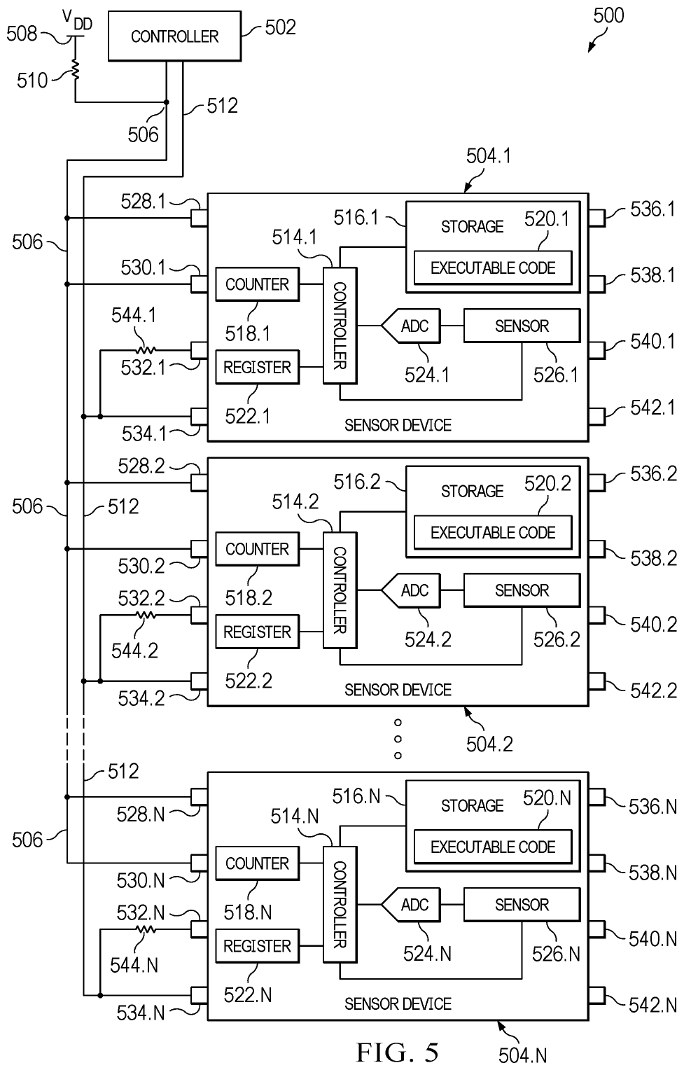

In some examples, a different technique may be useful for each of the sensor devices 204 to determine its index position in the chain of sensor devices 204. For instance, the controller 202 may communicate the index position of each sensor device 204 to that sensor device 204. In other examples, the sensor device 204 may be programmed (e.g., by a designer or engineer) with its index position such that the sensor devices 204 do not perform any steps to determine their index positions. Other techniques are contemplated and fall within the scope of this disclosure. For instance, FIG. 5 is a block diagram of an example sensor system 500 in which sensor devices in a chain of sensor devices use an alternative technique to identify their respective index positions in the chain. The example sensor system 500 may include components identical to those of sensor system 200 in FIG. 2 with like numerals referring to like components, with the exception of connections to the various pins of the sensor devices 204. In sensor system 500, pins 528.X {X=1 . . . N} may be coupled to SPDC 506; pins 530.X {X=1 . . . N} may be coupled to SPDC 506; and pins 532.X {X=1 . . . N} may be coupled to resistors 544.X {X=1 . . . N}, respectively, and these resistors may be coupled to ground connection 512. Pins 534.X {X=1 . . . N}, may be coupled to ground connection 512. Each of the resistors 544.X {X=1 . . . N} has a different resistance, which may be determined by an engineer or designer of the sensor system 500. Each sensor device 504 uses a respective pair of pins 532.X, 534.X {X=1 . . . N} to sense a voltage drop across its respective resistor 544.X {X=1 . . . N}. Each sensor device 504 is programmed (e.g., in the executable code 520.X {X=1 . . . N}) to interpret the sensed voltage drop as an index position of that sensor device 504 (e.g., by first quantizing the sensed analog voltage to a digital code and identifying a corresponding index position in a lookup table stored in storage 516.X {X=1 . . . N} (not expressly shown) that cross-references digital codes with index positions). In the example of FIG. 5, the pins 536.X, 538.X, 540.X, and 542.X {X=1 . . . N} are not used to determine index positions of the various sensor devices 504.

Referring again to FIGS. 2, 3, and 4, the method 400 includes each sensor device 204 determining a length of time T_{START} between receipt of a parameter sensing and/or conversion command from the controller 202 and when that sensor device 204 is to begin parameter sensing and/or conversion (block 408). Thus, T_{START} indicates the start time at which a respective sensor device 204 is to begin parameter sensing and/or conversion. Specifically, each sensor device 204 calculates a different value of T_{START} for that sensor device 204, where T_{START} is equal to the sum of T_{DELAY} (which is a fixed, programmed delay (e.g., programmed by an engineer or designer of the system 100) between receipt of the parameter sensing and/or conversion command from the controller 202 and the earliest time at which the sensor device 204.1 may begin its parameter sensing and/or conversion) and the product of the index position of that sensor device 204 and the maximum duration of time T_{DUR} taken to perform the parameter sensing and/or conversion:

T_{START}=T_{DELAY}+(index position)(T_{DUR}) (1)

Thus, each of the sensor devices 204 calculates a different value of T_{START}. For example, assuming a T_{DELAY} of 10 ms and a T_{DUR} for both parameter sensing and sensed parameter conversion to digital codes of 5 ms, the sensor device 204.1 may have a T_{START} value of

T_{START}=10 ms+(0)(5 ms)=10 ms (2)

which means that the sensor device 204.1 may begin its parameter sensing and conversion 10 ms after the command from the controller 202 has been fully received by the sensor device 204.1 (e.g., after the second edge, whether rising or falling, is received by the sensor device 204.1). The sensor device 204.2 may have a T_{START} value of

T_{START}=10 ms +(1)(5 ms)=15 ms (3)

which means that the sensor device 204.2 may begin its parameter sensing and conversion 15 ms after the command from the controller 202 has been fully received by the sensor device 204.2, and so on. Calculated T_{START} values may be stored in the storage 216.X {X=1 . . . N} of each sensor device 204.

After each sensor device 204 has calculated its value of T_{START} (block 408), each sensor device 204 sets its counter 218.X {X=1 . . . N} to equal the calculated value of T_{START} for that sensor device (block 410). The controller 202 may issue a reset command 312, and, upon receiving an answer signal 314, the controller 202 may issue a skip address command 316, followed by a convert sensed parameter command 318. Each of the sensor devices 204 receives the command 318, and responsive to receipt of the command 318, each of the sensor devices 204 initializes its counter (block 411) such that the counter begins counting down to the calculated value of T_{START} for that sensor device 204. In FIG. 3, curve 334 corresponds to the activity of the sensor device 204.1. Numeral 338 indicates the value of T_{DELAY}, defined above, and numeral 339 indicates the time at which T_{START} (as calculated for the sensor device 204.1 and as set in counter 218.1) elapses, thereby triggering sensor device 204.1 to sense a parameter (e.g., using a respective sensor, such as sensor 226.1) and convert that sensed parameter to a digital code (e.g., using ADC 224.1) (block 412). In examples, upon expiration of T_{START}, the sensor device 204.1 is triggered to convert a previously sensed and stored parameter (e.g., temperature) to a digital code. The sensing and/or conversion activity of the sensor device 204.1 lasts for a maximum time duration T_{DUR} 341, as the numeral 336 indicates. As curve 340 shows, because sensor device 204.2 has a longer T_{START} than sensor device 204.1, the counter 218.2 expires later than the counter 218.1, meaning the sensing and/or conversion activity of the sensor device 204.2 begins as shown at numeral 343. The sensing and/or conversion activity of the sensor device 204.2, which is indicated by numeral 342, lasts for a maximum time duration T_{DUR} 341. As curve 344 shows, because sensor device 204.N has a longer T_{START} than sensor device 204.2, the counter 218.N expires later than the counter 218.2, meaning the sensing and/or conversion activity of the sensor device 204.N begins as shown at numeral 345. The sensing and/or conversion activity of the sensor device 204.N, which is indicated by numeral 346, lasts for a maximum time duration T_{DUR} 341.

As the top-most diagram in FIG. 3 shows, the voltage on SPDC 206 remains above a threshold voltage V_{TL} 332 (the voltage below which sensor devices anticipate an impending instruction from the controller 202, as described above) during the successive sensing and/or conversion activities of the sensor devices 204. Specifically, at time 339, the voltage on SPDC 206 dips to a level 320, which is above V_{TL} 332. At time 343, the sensor device 204.2 begins its sensing and/or conversion activity, but the sensing and/or conversion activity of the sensor device 204.1 is not yet complete. Thus, the voltage on SPDC 206 is pulled lower than level 320 to level 322 during the time when the sensing and/or conversion activities of the sensor devices 204.1 and 204.2 overlap. When the sensing and/or conversion activity of the sensor device 204.1 is complete, but that of sensor device 204.2 is still continuing, the voltage on SPDC 206 rises to level 324. After the activity of sensor device 204.2 is complete but before the activity of sensor device 204.N begins, the voltage on SPDC 206 rises to a baseline level 326. Voltage activity on SPDC 206 during sensing and/or conversion activity of any sensor devices between sensor devices 204.2 and 204.N is not expressly shown. During the sensing and/or conversion activity of sensor device 204.N, the voltage on SPDC 206 again drops to a level 328, and after this activity is complete, the voltage on SPDC 206 rises to level 330. Because the total current draw of all sensor devices 204 sensing and/or converting sensed parameters to digital codes at any given time (e.g., the current draw per sensor device multiplied by the number of sensor devices 204 sensing and/or converting sensed parameters) is not sufficient to drop the voltage on SPDC 206 below V_{TL} 332, at no time does the voltage on SPDC 206 drop below V_{TL} 332, and thus the problems associated with such voltage drops on SPDC 206 as described above are mitigated or avoided altogether.

As numerals 336, 342, and 346 show, no more than two sensor devices 204 may be sensing parameters and/or converting sensed parameters to digital codes at a given time. In examples, the maximum number of sensor devices 204 sensing parameters and/or converting sensed parameters to digital codes does not exceed a predetermined target. This predetermined target may be determined based on the difference between V_{TL} 332 and the baseline voltage on SPDC 206. The larger the difference between V_{TL} 332 and the baseline voltage on SPDC 206, the more current draw may be accommodated on SPDC 206, and thus the more sensor devices 204 that may simultaneously perform parameter sensing and/or conversion. The baseline voltage on SPDC 206 may be determined at least in part based on V_{DD} 208 and the resistance of resistor 210, which determines the voltage drop from V_{DD} 208 to SPDC 206 and thus determines the baseline voltage on SPDC 206.

As the sensing and/or conversion activity of each sensor device 204 is completed, that sensor device 204 (e.g., the controller 214.X {X=1 . . . N} of that sensor device 204) stores the converted digital code to a respective storage 216.X {X=1 . . . N} (block 414). The controller 202 may subsequently interrogate the sensor devices 204 to obtain the digital codes (block 416).

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B. As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

As used herein, the terms “terminal”, “node”, “interconnection”, “pin”, “ball” and “lead” are used interchangeably. Unless specifically stated to the contrary, these terms are generally used to mean an interconnection between or a terminus of a device element, a circuit element, an integrated circuit, a device or other electronics or semiconductor component.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground connection” or “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero. Modifications are possible in the described examples, and other examples are possible within the scope of the claims.

What is claimed is:

1. A sensor device adapted to be coupled, by a shared power and data connection (SPDC), to other sensor devices in a chain of sensor devices, the sensor device comprising:
a sensor to sense a parameter;
a counter; and
a controller coupled to the sensor and the counter, the controller configured to:
determine, based on an index position of the sensor device, a time that is to elapse between receipt of a command to convert the sensed parameter to a digital code and a conversion of the sensed parameter to the digital code;
responsive to receipt of the command, set the counter to the time; and
convert the sensed parameter to the digital code upon the counter indicating that the time has elapsed.

2. The sensor device of claim 1, wherein the controller is configured to determine the time by summing a fixed delay and a product of the index position and a duration of the conversion.

3. The sensor device of claim 2, wherein the fixed delay represents a delay between the receipt of the command and a time at which a sensor device having a first index position in the chain begins a sensed parameter conversion.

4. The sensor device of claim 1, wherein the controller is configured to store the digital code in the sensor device.

5. The sensor device of claim 1, wherein the controller is configured to convert the sensed parameter to the digital code at a same time as N other sensor devices in the chain are performing sensed parameter conversions, wherein N+1 does not exceed a predetermined target.

6. The sensor device of claim 1, wherein:
to convert the sensed parameter to the digital code, the sensor device is configured to draw a current,
a product of the current and a predetermined target indicates a total current draw from the SPDC, and
the total current draw is sufficiently low such that, when the total current draw is being drawn from the SPDC, a voltage on the SPDC does not drop below a threshold voltage that the controller is configured to interpret as an indication that a message is to be received from a second controller to which the sensor device is adapted to couple via the SPDC.

7. The sensor device of claim 1, wherein the controller is configured to receive a skip address command prior to converting the sensed parameter to the digital code, the skip address command indicating that the controller is to execute the command to convert the sensed parameter to the digital code irrespective of an address of the sensor device.

8. The sensor device of claim 1, wherein the controller is configured to capture another digital code provided on multiple pins of the sensor device and to determine the index position of the sensor device based on the another digital code.

9. The sensor device of claim 1, wherein the controller is configured to measure a voltage across a resistor coupled to a pair of pins of the sensor device and to determine the index position of the sensor device based on the measured voltage.

10. A sensor device adapted to be coupled, by a shared power and data connection (SPDC), to other sensor devices in a chain of sensor devices, the sensor device comprising:
a sensor to sense a parameter; and
a controller coupled to the sensor, the controller configured to:
determine an index position of the sensor device;
calculate a time that is to elapse between receipt of a command to convert the sensed parameter to a digital code and the conversion of the sensed parameter to the digital code, the time being a sum of a fixed delay time and a product of the index position and a duration of the conversion; and
responsive to the time elapsing since the receipt of the command, convert the sensed parameter to the digital code.

11. The sensor device of claim 10, further comprising a register configured to store a representation of the index position.

12. The sensor device of claim 10, further comprising a pair of package pins adapted to be coupled to a resistor, and wherein the controller is configured to determine the index position using the resistor.

13. The sensor device of claim 10, further comprising a set of package pins coupled to one or more of the SPDC and a ground connection in a configuration that is unique among the sensor devices in the chain of sensor devices.

14. The sensor devices of claim 10, further comprising a counter configured to indicate elapsing of the time.

15. The sensor devices of claim 10, further comprising a package pin that is adapted to be coupled to a resistor and a power supply via the SPDC.

16. A method, comprising:
determining an index position of a sensor device in a chain of sensor devices coupled to each other by a shared power and data connection (SPDC) based on a first digital code provided to a set of pins of the sensor device or based on a sensed voltage on a pin of the sensor device;
calculating a time that is to elapse between receipt of a command to convert a sensed parameter to a digital code and the conversion of the sensed parameter to the digital code by summing a fixed delay time and a product of the index position and a duration of the conversion;
responsive to receiving the command, waiting for the time to elapse;
responsive to the time elapsing, converting the sensed parameter to a second digital code; and
storing the second digital code to a storage in the sensor device.

17. The method of claim 16, wherein the fixed delay time is a delay between receipt of a command from a controller to convert the sensed parameter to the digital code and a time at which a first sensor device in the chain of sensor devices performs a sensed parameter conversion.

18. The method of claim 16, wherein determining the index position of the sensor device comprises determining a voltage drop across a resistor coupled to two pins of a semiconductor package containing the sensor device.

19. The method of claim 16, wherein determining the index position of the sensor device includes determining which of a set of package pins is coupled to a ground connection and which of the set of package pins is coupled to the SPDC.

20. The method of claim 16, further comprising setting a counter based on the time and converting the sensed parameter responsive to expiration of the counter.
